(19) United States
(12) Patent Application Publication
(10) Pub. No.: US 2005/0083336 A1
(43) Pub. Date: Apr. 21, 2005

(54) Information processing apparatus and information processing method thereof

(75) Inventor: Meeko Kuwahara, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/804,293

(22) Filed: Mar. 18, 2004

(30) Foreign Application Priority Data
Sep. 18, 2003 (JP) 2003-325408

(51) Int. Cl. G11B 27/02

(52) U.S. Cl. 345/530

(57) ABSTRACT

When data necessary for executing functions not stored in an information processing apparatus are primary data and secondary data, the functions not originally mounted in the information processing apparatus are executed by acquiring the primary data from a memory, and the secondary data from another apparatus through the intermediary of an interface. Thus, even with a recording and reproduction apparatus which does not store software necessary for implementing various functions in recording, transmitting, and displaying data, because of insufficient hardware resources, the various functions for recording, transmitting, and displaying the data can be implemented.

### BACKGROUND OF THE INVENTION

1. Field of the Invention

The present invention relates to information processing technology, and, in particular, to information processing technology enabling functions not on the motherboard of a recording and reproduction apparatus. The device itself is implemented by obtaining the functions from another apparatus.

2. Description of the Related Art

An apparatus is known for transmitting and receiving the data needed for reproduction and display using communication means when a reproduction function is used. For example, JP-A No. 325221/2002, discloses a recording and reproduction apparatus for downloading information on a play list to a recording medium with the information already recorded therein, by connecting the recording and reproduction apparatus to an external server and recording the information on the play list to allow reproducing the information in accordance with the play list.

JP-A No. 354149/2002, discloses a portable terminal wherein an inquiry is sent to image pickup apparatuses within communication range to thereby establish a connection with one image pickup apparatus responding to the inquiry. A request for image list information is sent to the image pickup apparatus to choose the class of data to be received based on the image list information. Then a request for the selected class of data is sent to the image pickup apparatus, and a request for images selected is sent to the image pickup apparatus, thereby effecting receipt of the images.

With a recording and reproduction apparatus having a conventional communication function, to transmit and display data being recorded or already recorded by communicating with another apparatus, software used to be pre-mounted in the recording and reproduction apparatus itself or in the other apparatus. Unless software is installed in the recording and reproduction apparatus or in the other apparatus, it is difficult to transmit and display data being recorded or already recorded by communicating with another apparatus.

With recording and reproduction apparatus, particularly portable equipment such as a camera, however, it is difficult to store all the necessary software for transmission and display of data, because memory and other hardware resources are limited.

### BRIEF SUMMARY OF THE INVENTION

This invention provides information processing technology capable of implementing various functions in recording, transmitting, and displaying data, even when insufficiency of hardware resources makes it impossible to install all the software necessary for implementing the various functions in recording, transmitting, and displaying data. To that end, with the invention, the functions not mounted in a recording and reproduction apparatus are implemented by receiving the necessary data from another apparatus through a communication means.

With the invention, even in the case of a recording and reproduction apparatus wherein it is not possible to mount the software necessary for implementing various functions in recording, transmitting, and displaying data, because of insufficient hardware resources, the various functions for recording, transmitting, and displaying the data can be implemented.

### BRIEF DESCRIPTION OF THE DRAWINGS

FIG. 1 is a block diagram of hardware for two embodiments.

FIG. 2A is a conceptual illustration showing the disposition of common software for one embodiment;

FIG. 3 is a flowchart explaining selection of function data for image pick up according to the embodiment of FIG. 1;

FIG. 4 is a flowchart showing procedural steps in selection of function data for image pick up;

FIGS. 5A and 5B are illustrations showing the disposition of common software shown for another embodiment;

FIG. 6A shows a browsing screen for the configuration of one embodiment and FIG. 6B shows a browsing screen for another embodiment; and

FIG. 7A shows a flowchart for an example using the configuration shown in FIG. 5A; while FIG. 7B shows a flowchart according to a further embodiment.

### DETAILED DESCRIPTION OF THE INVENTION

Embodiments of the invention are described hereinafter. The outline of the embodiments is as follows. With reference to software, for use at a time of recording image pickup data while applying a special process thereto, and software (particularly, a graphics data portion requiring a large storage capacity) such as an editing program, the software incorporated of a second recording and reproduction apparatus is used as necessary by executing communication with the first recording and reproduction apparatus when a user makes use of the functions of the software, so that even portable equipment with insufficient hardware resources can implement various functions.

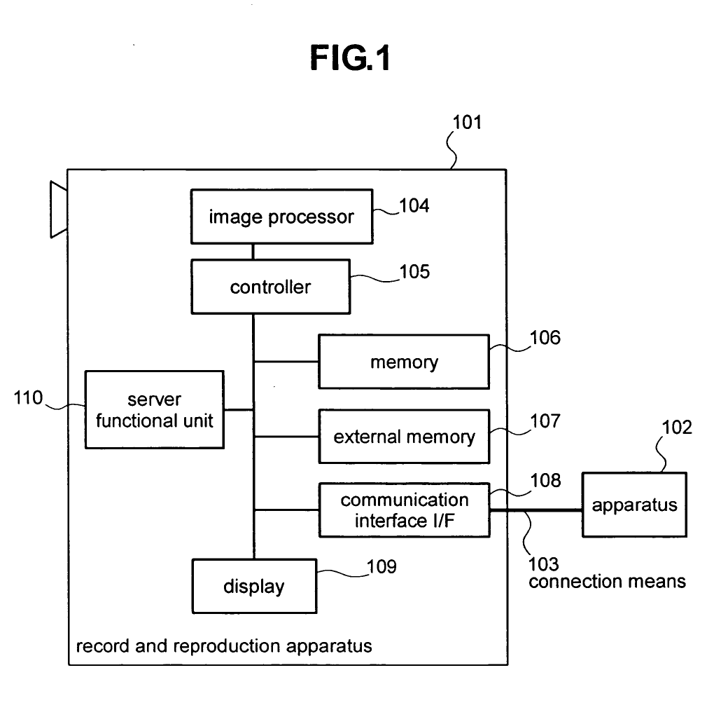

FIG. 1 is a block diagram of hardware. Using recording and reproduction apparatus 101 as an example of an information processing apparatus, an image processor 104 executes processing of image information delivered from an image pickup device (not shown). A controller 105 controls various devices for image pickup and various processing, and also controls a power source and conditions of peripheral devices. A memory 106 is used as the work memory of software, a buffer for storing image pickup data, and a buffer for storing communication information. An external memory 107 records the image information processed by image processor 104 in the recording media (not shown). A communication interface I/F 108 controls data transmission with the other apparatus 102. A display 109 displays the image information.

Recording and reproduction apparatus 101 is connected to other apparatus 102 by connection means 103 for transmission through-a wire such as a cable, or by wireless transmission. Further, a server functional unit 110 is provided.

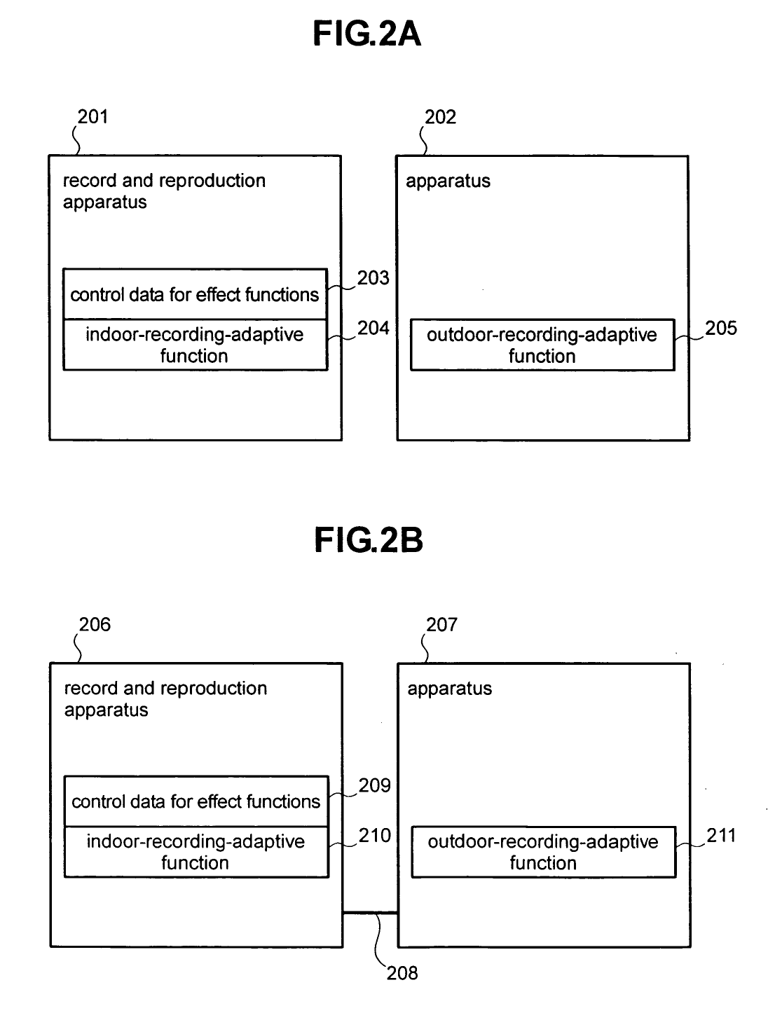

A first embodiment, which can be implemented with the use of the hardware shown in FIG. 1, is now described. FIG. 2 is a conceptual illustration showing disposition of software according to the first embodiment. A recording and reproduction apparatus 201 corresponds to the recording and reproduction apparatus 101 shown in FIG. 1. An apparatus 202 corresponds to the apparatus 102 shown in FIG. 1. Control data 203 controls function data for use when recording picked-up images in recording and reproduction apparatus 201. Indoor-recording-adaptive function data 204 are function data suitable for indoor-image-pickup recording. Control data 203 and indoor-recording-adaptive function data 204 are individually stored in memory 106. Outdoor-recording-adaptive function data 205 are function data stored in apparatus 202, suitable for outdoor-image-pickup recording.

When executing indoor-image-pickup recording with recording and reproduction apparatus 201, controller 105 causes image processor 104 to process image pickup data by utilizing control data 203 and indoor-recording-adaptive function data 204, stored in memory 106. The processed image pickup data are recorded on the recording medium by external memory 107. During image-pickup recording, images are sent to display 109 by controller 105, so that a user can check the images. Further, controller 105 fetches the image pickup data from the recording medium by controlling external memory 107, and image processor 104 processes, as necessary, the image pickup data fetched before sending the same to display 109, thereby enabling the user to see the image pickup data already recorded. Control data 203, indoor-recording-adaptive function data 204, and outdoor-recording-adaptive function data 205 are program data.

When executing outdoor-image-pickup recording with recording and reproduction apparatus 201, it is appropriate to execute image-pickup recording using outdoor-recording-adaptive function data 205. However, there is no choice other than using indoor-recording-adaptive function data 204, because storing outdoor-recording-adaptive function data 205 and maintaining it as suitable for use at a later time, in recording and reproduction apparatus 201 is impossible because the hardware resources are insufficient.

FIG. 2B is a conceptual illustration showing disposition of software according to the present embodiment. A record and reproduction apparatus 206 corresponds to record and reproduction apparatus 101 shown in FIG. 1. An apparatus 207 corresponds to apparatus 102 shown in FIG. 1. Connection means 208 corresponds to connection means 103 in FIG. 1. Control data 209 control function data for use when recording in the recording and reproduction apparatus 206. Indoor-recording-adaptive function data 210 are function data suitable for indoor-image-pickup recording. Outdoor-recording-adaptive function data 211 are function data suitable for outdoor-image-pickup recording, and are stored in apparatus 207, but can be utilized in recording and reproduction apparatus 206 as well.

When executing outdoor-image-pickup recording with recording and reproduction apparatus 206, controller 105 causes image processor 104 to process the image pickup data by using indoor-recording-adaptive function data 210 stored in memory 106. The processed image pickup data are recorded on the recording medium by external memory 107.

If controller 105 determines at this point that outdoor-recording-adaptive function data 211 stored in apparatus 207 are more appropriate for processing the image pickup data than indoor-recording-adaptive function data 210 stored in memory 106, recording and reproduction apparatus 206 and apparatus 207 are connected with each other by connection means 208 through-wire or wireless transmission, whereupon control data 209 stored in memory 106 and indoor-recording-adaptive function data 211 are used in recording and reproduction apparatus 206 to effect image pickup. During recording are sent to display 109 by controller 105, so that the user can check the images. Further, images already recorded are also displayed for the user after controller 105 fetches the image pickup data from the recording medium by controlling external memory 107, and image processor 104 processes, as necessary, the image pickup data fetched to be sent to display 109. The same applies when indoor-recording-adaptive function data (effect function) 210 suitable for indoor-image-pickup recording is used on the part of apparatus 207. Since both the apparatuses can have the data in common in this way, more functions can be used, thereby enabling functions and operability to be enhanced.

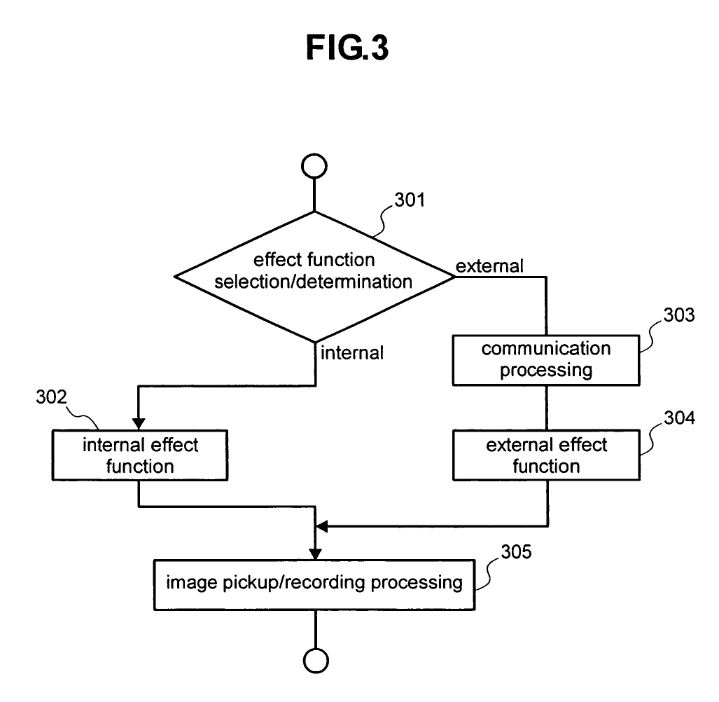

FIG. 3 is a flowchart for a first embodiment. When image pickup is started with recording and reproduction apparatus 101 or apparatus 102, controller 105 selects and determines whether or not necessary function data are in memory 106, or external memory 107 in Step 301. If controller 105 selects the necessary function data at this point and determines that the data exists internally, controller 105 causes processing to be executed at image processor 104 using the function data stored in memory 106 or in external memory 107 in Step 302. If controller 105 determines that the necessary function data are externally stored at the time of image pickup, communication interface I/F 108 executes communication processing in Step 303, and image processor 104 is made to process the image pickup data using an external effect function in Step 304, while controller 105 records data with image pickup/recording processing applied thereto in external memory 107 in Step 305.

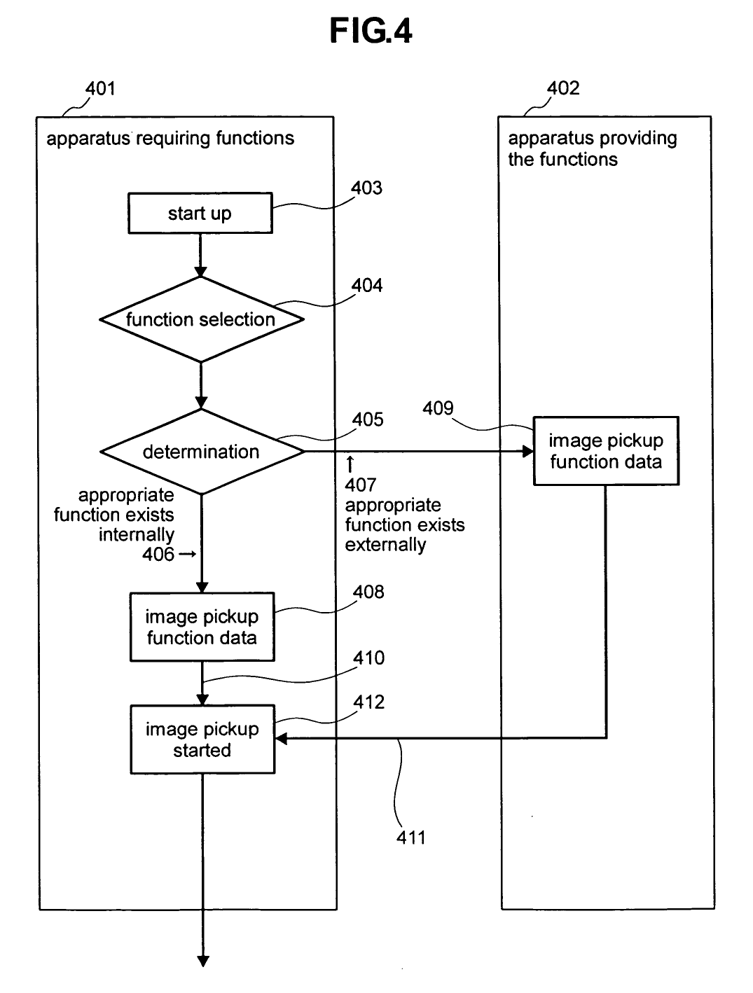

FIG. 4 is a flowchart showing the above-described steps in sequence. Reference numeral 401 denotes an apparatus requiring functions (recording and reproduction apparatus 101 in FIG. 1), and 402 denotes an apparatus providing the functions (apparatus 102 in FIG. 1). Apparatus 401 is started up (Step 403) and executes function selection for image pickup (Step 404). Apparatus 401 determines which internal function and external function connected thereto is appropriate as the necessary function (Step 405). If an appropriate function exists internally (apparatus 401), a request for image pickup function data 408 is made (Step 406), whereas if the appropriate function exists externally (apparatus 402), a request for image pickup function data 409 is made (Step 407). If the appropriate function exists inside apparatus 401, data transmission of the function is executed without further processing (Step 410) to thereby start image pickup (Step 411).

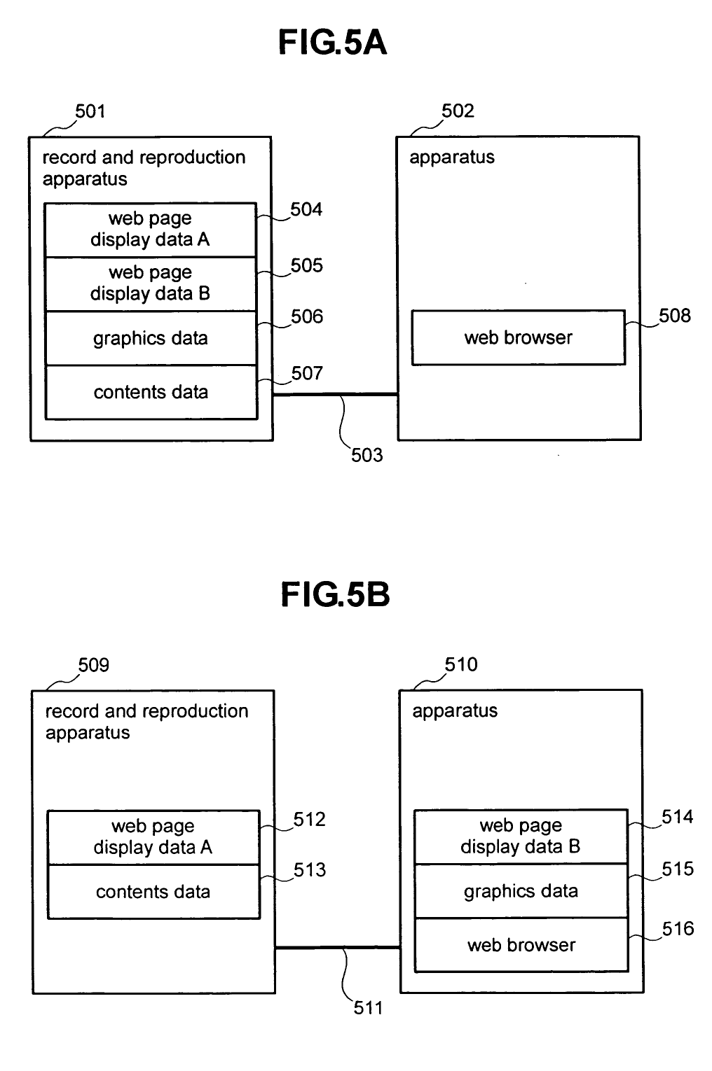

A configuration example of another embodiment is described with reference to FIG. 5. FIG. 5A is a conceptual illustration showing disposition of common software shown for expediency in describing the present embodiment. A recording and reproduction apparatus 501 corresponds to the recording and reproduction apparatus 101 shown in FIG. 1. An apparatus 502 corresponds to the apparatus 102 shown in FIG. 1. Connection means 503 corresponds to the connection means 103 in FIG. 1. Reference numerals 504 to 508 each denote data necessary for operating, transmitting, and receiving data using a web browser with recording and reproduction apparatus 501 and apparatus 502. Browser display data A 504 are the main constituent data of a web page. Browser display data B 505 are constituent data of the web page. Graphics data 506 are for use in design of the web page. Contents data 507 are control data for contents data in the recording and reproduction apparatus 501, contents data. Web browser 508 is a fully functional browser capable of web-lounging.

Server functional unit 110 of the recording and reproduction apparatus 101 in FIG. 1 is an HTTP server. When operating the contents data in the recording and reproduction apparatus 501 with apparatus 502, which is an external apparatus, server 110 sends a request to recording and reproduction apparatus 501 through connection means 503 using the web browser, and receives constituent data 504 to 506 of the web page stored therein to execute operation of contents data 507 using web browser 508. When recording and reproduction apparatus 501 is an apparatus such as a portable terminal, in which hardware resources are insufficient, it is difficult to store therein graphics data and the like, which require a large hard disk capacity. For this reason, the web page needs be configured so as not to use data requiring a large hard disk capacity, such as for graphics and the like. Further, on a navigation screen as well as a control screen of recording and reproduction apparatus 509, similar effects can be obtained using graphics data and the like separately stored in apparatus 502.

FIG. 5B is a conceptual illustration showing disposition of software according to the present embodiment. Recording and reproduction apparatus 509 corresponds to recording and reproduction apparatus 101 shown in FIG. 1. Apparatus 510 corresponds to apparatus 102 shown in FIG. 1. Connection means 511 correspond to connection means 103 in FIG. 1. Reference numerals 512 to 516 each denote data necessary for operating, transmitting, and receiving contents data using a web browser with recording and reproduction apparatus 509 and apparatus 511. Browser display data A 512 are main constituent data of a web page. Contents data 513 are control data for contents data in recording and reproduction apparatus 509, and contents data. Browser display data B 514 are constituent data of the web page. Graphics data 515 are for use in design of the web page. Web browser 516 is a browser capable of web-lounging. Server functional unit 110 of recording and reproduction apparatus 101 in FIG. 1 is an HTTP server, and apparatus 510 is an apparatus larger in hard disk capacity than the recording and reproduction apparatus 509. Connection means 511 for connecting recording and reproduction apparatus 509 to apparatus 510 are means for wireless transmission. When recording and reproduction apparatus 509 is an apparatus such as a portable terminal, for which hardware resources are insufficient, it is difficult to store therein graphics data and the like that require a large hard disk capacity. When operating the contents data in recording and reproduction apparatus 509 with apparatus 510, which is an external apparatus, data 512 to 516, necessary for operating, transmitting, and receiving the contents data by use of a web browser, are separately stored. The browser display data B 514 and graphics data 515, large in data capacity and data-separable, respectively, are stored in apparatus 510 which has greater hard disk capacity than recording and reproduction apparatus 509. In this way, the web page can be configured, resulting in enhancement in design characteristics and ease of operation by a user.

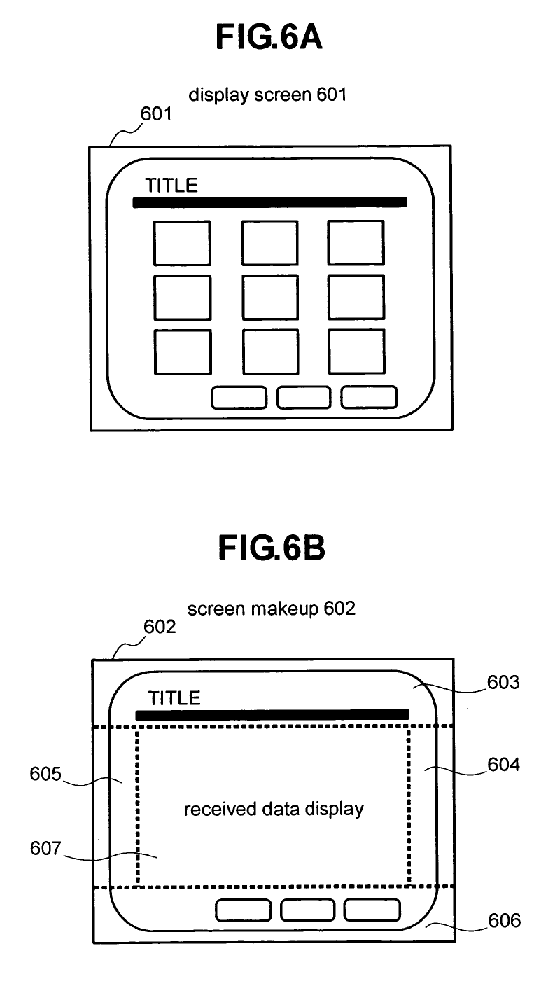

Display examples for another embodiment are browsing screens shown in FIG. 6. FIG. 6A shows an example of a display screen 601 when using the configuration shown in FIG. 5A. FIG. 6B shows an example of a display screen 602 when using the configuration shown in FIG. 5B, that is, the configuration of another embodiment. In FIG. 6B, frames (partition frames) 603 to 607 make up a web page. In designing a page that can be displayed by the web browser, such as display screen 601, a multitude of browser display data and graphics data are required.

However, because it is difficult to store all the browser display data and graphics data making up the web page shown in the example, in recording and reproduction apparatus 101, all data contained in the frames, other than frame 607, are stored in apparatus 102. Data contained in frame 607 include data being controlled by apparatus 101, and are therefore stored in that apparatus. Those data can be separately stored, and operational convenience from a user's point of view is the same as that in the case of a common web page for storing all data in either of the apparatuses. That is, even in a situation where graphics data and the like are not stored in recording and reproduction apparatus 101, for which hardware resources are insufficient, display and operation can be executed as for a high-quality web page.

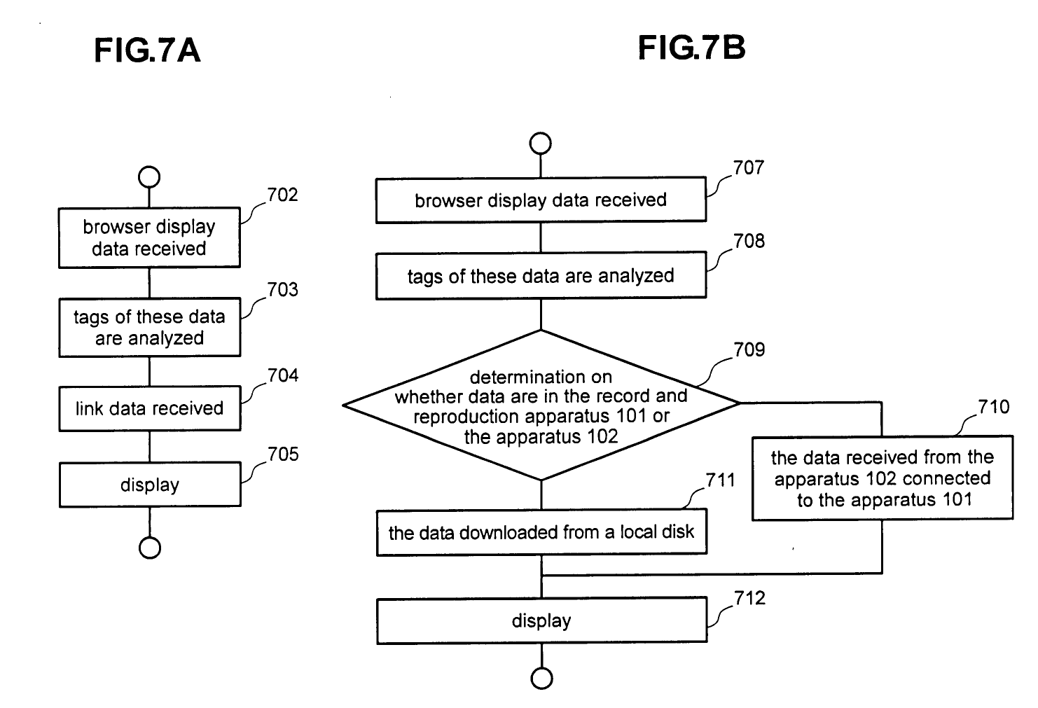

Now, receiving of respective data is described with reference to FIG. 7, a data reproduction flowchart. FIG. 7A shows a web browsing flow using the configuration shown in FIG. 5A. Apparatus 102 requests the browser display data from recording and reproduction apparatus 101 to acquire desired data. In Step 702, the browser display data are received, and in Step 703, tags of these data are analyzed. In Step 704, link data from the analyzed data are requested and received. Then, a display is executed at web browser 508 and kept on a local disk.

FIG. 7B shows, browsing flow, which uses the configuration shown in FIG. 5B, that is, the configuration of another embodiment. Apparatus 102 requests the browser display data from recording and reproduction apparatus 101 to acquire desired data. At Step 707, the browser display data are received, and at Step 708, tags of these data are analyzed. Thereupon, at Step 709, determination is made of whether the data are in recording and reproduction apparatus 101 or in apparatus 102, and at Step 710, the data are either received from apparatus 102, which is an external apparatus connected to apparatus 101, or at Step 711, the data are downloaded from a local disk, to thereby be displayed by web browser 516 (not shown), which is kept on a local disk. Further, acquisition of the data from other apparatuses is possible. As a result, operability as well as design characteristics of apparatus 102 is enhanced.

1. An information processing apparatus comprising:
a memory storing first data;
a controller configured to control the information processing apparatus; and
an interface configured to execute data communication with another apparatus, wherein in the case where data necessary for executing functions not mounted in the information processing apparatus comprise first data and second data, the functions not mounted in the information processing apparatus are executed by acquiring the first data from the memory and acquiring the second data from the another apparatus through the interface.

2. The information processing apparatus according to claim 1, wherein the controller determines whether functions to be executed are functions mounted in the information processing apparatus, and for functions not mounted in the information processing apparatus, the functions are executed by acquiring the second data from the another apparatus through the interface.

3. The information processing apparatus according to claim 1, wherein for requests for functions not mounted in the information processing apparatus, data necessary for executing the functions requested are transmitted to the another apparatus through the interface.

4. The information processing apparatus according to claim 1, wherein information necessary for executing the functions comprises program data.

5. The information processing apparatus according to claim 1, wherein information necessary for executing the functions comprises graphics data.

6. An information processing method comprising:
acquiring first data from a memory;
acquiring second data from the other apparatus through the intermediary of an interface; and
executing functions not mounted in the information processing apparatus using the first data and the second data.

7. A information processing method according to claim 6, wherein if a request for functions mounted in the information processing apparatus is made by the other apparatus, data necessary for executing the functions as requested are transmitted to the other apparatus through the intermediary of the interface.

8. The information processing method according to claim 6, wherein information necessary for executing the functions is program data.

9. The information processing method of an information processing apparatus according to claim 6, wherein information necessary for executing the functions is graphics data.

10. An information processing method comprising:
determining whether or not functions to be executed are functions mounted in the information processing apparatus;
acquiring first data from a memory, and second data from the other apparatus through the intermediary of an interface in the case of executing functions not mounted in the information processing apparatus, and
executing the functions not mounted in the information processing apparatus by use of the first data and the second data.

11. The information processing method according to claim 10, wherein if a request for the functions not mounted in the information processing apparatus is made by the other apparatus, data necessary for executing the functions as requested are transmitted to the other apparatus through the intermediary of the interface.

12. The information processing method of an information processing apparatus according to claim 10, wherein information necessary for executing the functions comprises program data.

13. The information processing method of an information processing apparatus according to claim 10, wherein information necessary for executing the functions comprises graphics data.
